(19) United States
(12) Patent Application Publication
(10) Pub. No.: US 2020/0289861 A1
(43) Pub. Date: Sep. 17, 2020

(54) FIRE RATED PET DOOR ASSEMBLY AND ACTIVATION SYSTEM

(71) Applicants: Richard E. Venturini, Petaluma, CA (US); Melanie M. Hildebrand, Petaluma, CA (US); John T. Brayton, Petaluma, CA (US)

(72) Inventors: Richard E. Venturini, Petaluma, CA (US); Melanie M. Hildebrand, Petaluma, CA (US); John T. Brayton, Petaluma, CA (US)

(21) Appl. No.: 16/724,971

(22) Filed: Dec. 23, 2019

Related U.S. Application Data
(60) Provisional application No. 62/818,995, filed on Mar. 15, 2019.

(51) Int. Cl. A62C 2/24; E06B 7/32; A01K 1/035

(52) U.S. Cl. CPC A62C 2/24; E05Y 2900/132; A01K 1/035; E06B 7/32

(57) ABSTRACT

A fire rated pet door closure and assembly adapted to be mounted on the attached garage side of a fire wall or fire door in part defining an enclosure such as a house or living area over a pet door access passageway opening from the inside of the fire wall or fire door to the outside thereof which pet door is normally selectively open, for pet egress. The onset of a fire/heat emitting emergency mechanical fusible apparatus is provided such that the fire rated pet door closure supporting release link apparatus with a predetermined release temperature activates a latch support for the fire rated pet door closure panel which automatically closes via gravity sealing the pet door access passageway with intumescent smoke and draft seals.

This application claims the benefit of U.S. Provisional Application No. 62/818,995, filed on Mar. 15, 2019.

### BACKGROUND OF THE INVENTION

### 1. Technical Field

The invention relates generally to a pet door assembly and activation system.

Currently there are no solutions for fire rated pet doors. Some of the pet doors attempt to address egress and ingress only or open with an alarm, but these solutions fail to meet the building and fire rating codes required because current pet doors are not fire rated. In the field of fire safety, it is well known that openings from a residential living area to a garage must be approved and fire rated. Any homeowner or his agent that cuts an opening in a fire wall from the living area to the garage invalidates the fire rating assembly requirements from fire and building departments and is illegal and not to code. It is further well known that insurance companies can invalidate the homeowner's insurance claim and not pay for damages if any opening for a non-rated fire door opening was installed that does not meet fire and building codes. It would be desirable to have a fire rated pet door assembly with a mechanical fusible link used in residential garage walls or access doors to seal an opening if a fire and heat hazard condition arises. Therefore, there currently exists a need in the industry for a fire rated pet door in order to meet present fire and building codes when a pet door is installed in a fire rated door or wall. Also, homeowner's insurance coverage does not pay if the pet door does not meet fire and building codes.

### 2. Description of Prior Art

Prior art emergency pet doors have been directed to the pet egress during emergency such as fire and smoke. Examples of such prior art patents all dedicated to the pet door activation for express egress during such emergencies in the following U.S. patents; U.S. Pat. Nos. 5,651,331, 6,049,287, 8,464,663, 9,157,269.

In U.S. Pat. No. 5,651,331 a pet escape device is disclosed having a pet passageway normally closed which is open during activation by emergency with the owner's voice recording urging the pet to use the door and escape to safety.

U.S. Pat. No. 6,049,287 claims a door with an integrated smoke detector and apparatus which holds the pet door open upon activation allowing the pet to escape.

U.S. Pat. No. 8,464,663 is directed to an animal egress from a secure location during an emergency defined as smoke, gas or odor. A pre-recorded message once activated from the owner urges the pet to leave through the now open access pet door.

Finally, in U.S. Pat. No. 9,157,269 a device is illustrated that an automatic pet door is controlled by a smart phone wherein the pet door has multiple access control modes using a smart phone application for remote activation and setting.

### DESCRIPTION OF THE DRAWINGS

FIG. 1 is a front elevational view of a fire rated pet door of the present invention with the door raised for illustration.

FIG. 2 is a front elevational view thereof in operational use position.

FIG. 3 is a perspective view thereof.

FIG. 4 is a side view thereof within a wall with portions broken away.

FIG. 5 is a top plan partial sectional view of the pet door of the invention.

FIG. 6 is an enlarged schematic diagram of the mechanical fusible line release assembly.

### DETAILED DESCRIPTION OF THE INVENTION

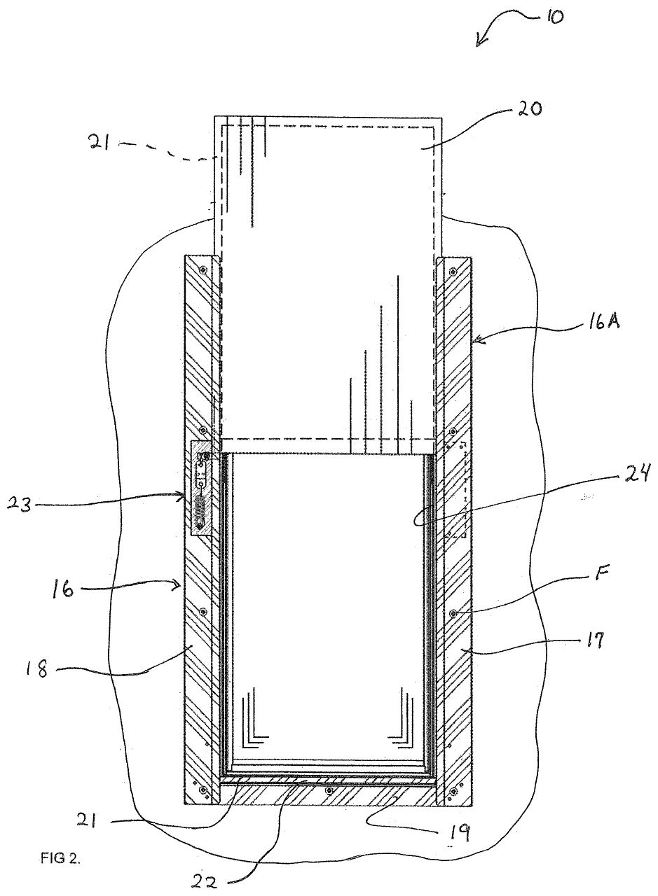

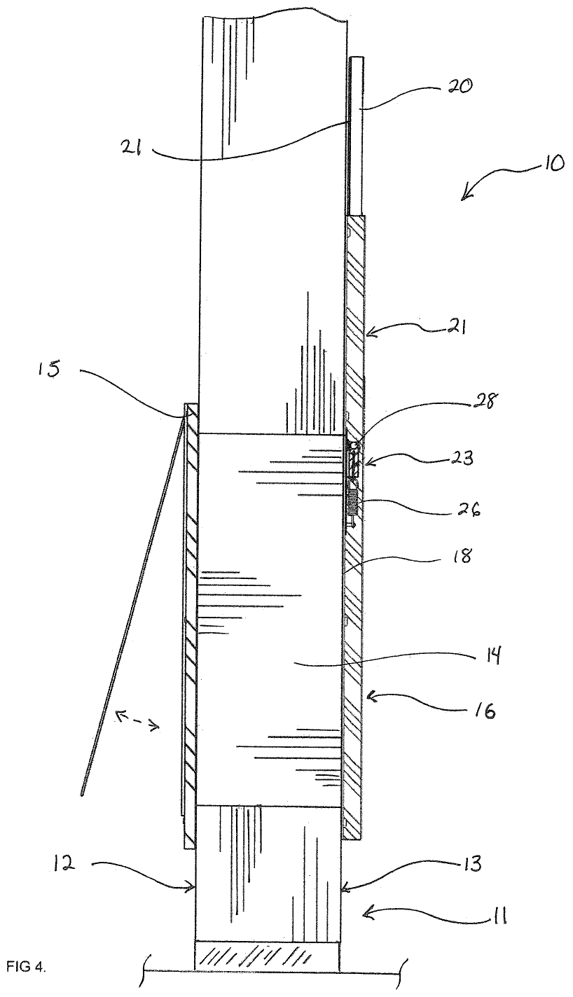

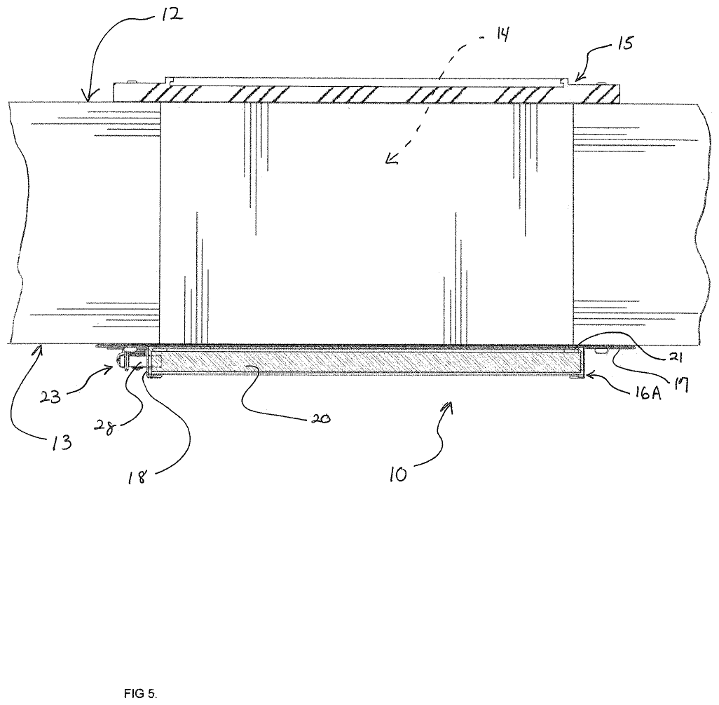

Referring to FIGS. 2, 4 and 5 of the drawings, a pet door fire closure 10 of the present invention can be seen mounted on the attached garage side of a fire rated wall or access door 11 to a structure such as a house with a living area, not shown. Although the description of the invention will be made with respect to a conventionally studded wall such as found in modernly constructed houses, it will be evident that other wall or door constructions may be utilized to accommodate the pet door fire closure 10. The fire rated wall or door 11 defines an inside living area surface 12 and a garage side surface 13 laterally separated therefrom and a normally open pet access passageway 14 positioned there through. The passageway 14 has a two-way pet door and frame 15 being attached on the living area defined surface 12 in the example.

The pet door fire closure 10 of the invention has a generally U-shaped outer support frame 16 with spaced parallel side, frame elements 17 and 18 and an interconnected bottom frame element 19. The frame elements 17-19 have longitudinally integrally extending flanges, each with a plurality of aligned longitudinally spaced apertures A therewith for receiving registering fasteners F for securing to the garage side surface 13 when so positioned about the hereinbefore described pet access passageway 14.

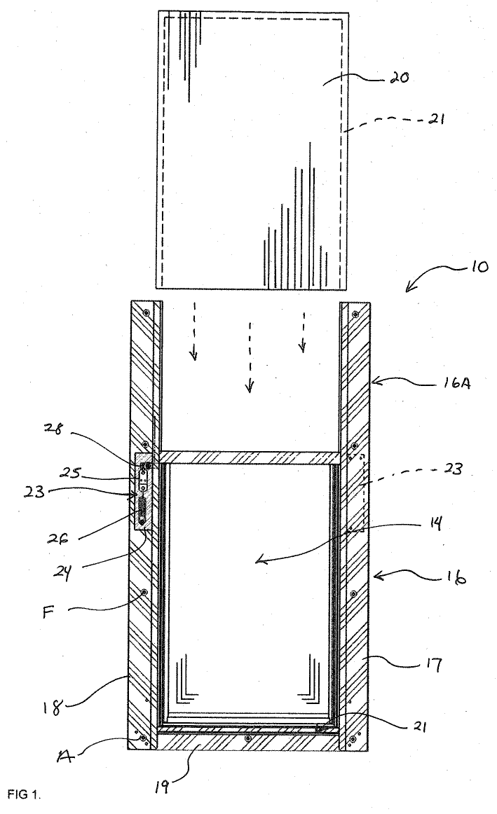

A non-combustible fire rated closure panel 20 is slidably disposed within an upper frame extending portions 16A of the support frame 16, as seen in FIGS. 1, 2 and 3 of the drawings.

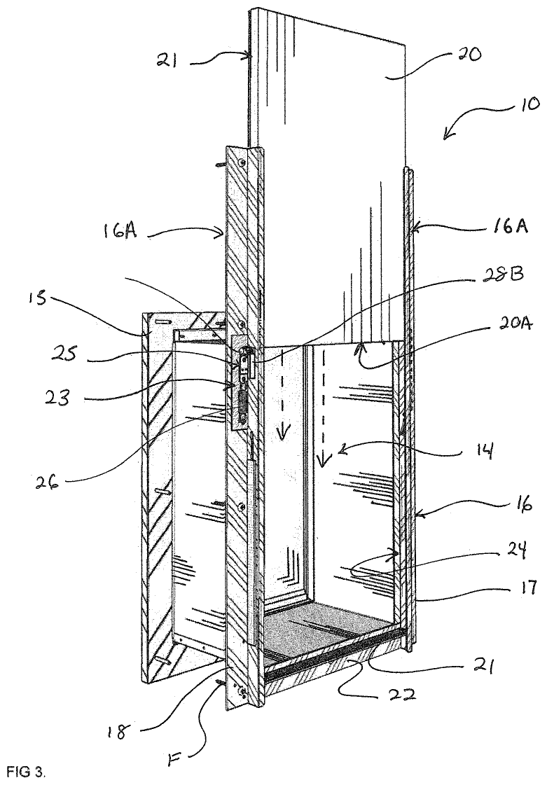

To assure a smoke seal during closure panel 20 activation and deployment, as will be disclosed in greater detail hereinafter, an adhesive back band of intumescent material 21 is applied around the frame engagement surface of the fire rated closure panel 20 shown in broken lines in FIGS. 1 and 2 of the drawings and along the bottom rail portion 22 of the frame 16 as seen in FIGS. 2 and 3 of the drawings. Intumescent material 21 is well known in the art having the property to expand with the application of heat forming an expanding sealing surface in this application between the panel 20 and the frame 16 when so activated.

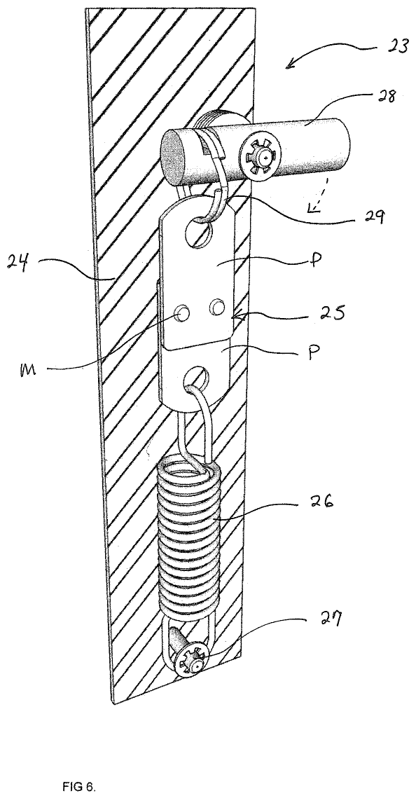

Referring now to FIGS. 1, 2 and 6 of the drawings, a fusible release link latch assembly 23 can be seen having a mounting plate 24 with a fusible link element 25 held between an extension and tensioning spring 26 on a retainment pin 27 and a closer door support rod 28 by a split ring 29.

The door support rod 28 is pivotally attached to the mounting plate 24 by a pivot pin 28A and extends through an opening in the frame 18 for retainment engagement with a bottom edge 20A of the closure panel 20 thereby holding the panel 20 in open position.

The fusible link element 25 is well known in the art having a temperature sensitive material M between two connecting plates P that effectively melts upon reaching the predetermined temperature which is indicative of a fire and releases thereby under the spring 26 tension allowing the door support rod 28 to freely pivot under the weight of the closure panel 20 releasing the panel 20 for sealing engagement within the pet access passageway 14. The non-combustible fire rated closure panel 20 can be of a variety of materials within the scope as defined under the fire predicted performance classification within the art. It will be evident that given the orientation and nature of the closure panel 20 during activation that the pet access passageway 14 and its defined engagement surface would provide an overlapping registration seal, as noted, for the closure panel 20 as hereinbefore described. As noted, upon fusible link latch assembly 23 activation by release of the fusible link 25 the rod 28 will rotate freely and the closure panel 20 will be released dropping down by gravity into a closed position over the pet access passageway 14 indicated by the transitional broken lines generally in FIG. 2 of the drawings. It will be evident from the above description that once the closure panel 20 has been released and dropped into place against the closure engagement surface 24 and the heat activated intumescent tape 21 expands and an effective fire stop barrier will be achieved with a smoke and draft seal to maintain between the adjacent described interiors thereby maintaining the code fire requirements for separation of a garage and living space as currently understood.

The pet access passageway 14 defines a closure engagement surface 24 there about which would provide an overlapping registration seal for the closure panel 20 upon release activation as herein before described.

The composition of the non-combustible fire rated closure panel 20 can be a variety of materials that come within the scope as defined under adapted fire product performance classifications.

It will thus be seen that a new and novel fire rated pet door assembly and activation system has been illustrated and described and that various changes and modifications may be made thereto without departing from the spirit of the invention.

Therefore, I claim:

1. A fire rated safety closure for a pet door comprises,
a support and guide frame secured about a pet door opening in a fire rated wall or door in a structure,
a slidably disposed closure panel retained within said guide frame,
said closure panel movable from a first open door access default position to a second closed sealing position upon activation,
said closure panel comprised of fire-resistant material,
a heat selective activation link latch assembly on said support and guide frame in communication with said closure panel in default open position,
heat activated sealing material on said closure panel and a portion of said support and activation frame.

2. The fire rated safety closure for a pet door set forth in claim 1 wherein said support and guide frame comprises, spaced parallel side frame elements and an interconnecting bottom frame element.

3. The fire rated safety closure for a pet door set forth in claim 2 wherein said side and interconnecting frame elements define guide and engagement channels for said closure panel.

4. The fire rated safety closure for a pet door set forth in claim 2 wherein portions of said guide frame extend beyond the pet door defined opening.

5. The fire rated safety closure for a pet door set forth in claim 1 wherein said selectively activated link latch assembly comprises,
a closure door support rod pivotally secured to said frame, a fusible link extending from said support rod,
a resilient element in communication with said fusible link and a retainment pin on said frame in spaced aligned vertical relation to said fusible panel.

6. The fire rated safety closure for a pet door set forth in claim 1 wherein said sealing material on said closure panel and portion of said interconnecting support and guide frame comprises,
an applied band of intumescent material that expands upon exposure to heat forming a seal.
